(19) United States
(12) Patent Application Publication
(10) Pub. No.: US 2004/0017317 A1
(43) Pub. Date: Jan. 29, 2004

(54) Antenna and method of design

(76) Inventor: Uwe Schmiade, Romsey (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/424,991

(22) Filed: Apr. 29, 2003

(30) Foreign Application Priority Data
Apr. 30, 2002 (GB) 0209828.3
May 17, 2002 (GB) 0211264.7

(51) Int. Cl. H01Q 1/38

(52) U.S. Cl. 343/700 MS

(57) ABSTRACT

A method of designing an antenna (6) comprises at least two iterations (8, 10); wherein a first iteration (8) comprises applying a first order fractal replication (b) to a base shape (7); and wherein a subsequent iteration (10) comprises applying a non-linear replication to the result of the first or each previous iteration (8, 9); such that a predetermined antenna radiation pattern is produced (11). An antenna comprises at least two elements; wherein the first element comprises a base shape (7) to which a first order fractal replication (b) has-been applied; and wherein a subsequent element comprises a non-linear replication of the first or each subsequent element, such that a predetermined antenna radiation pattern is produced (11).

This invention relates to an antenna and a method of designing the antenna.

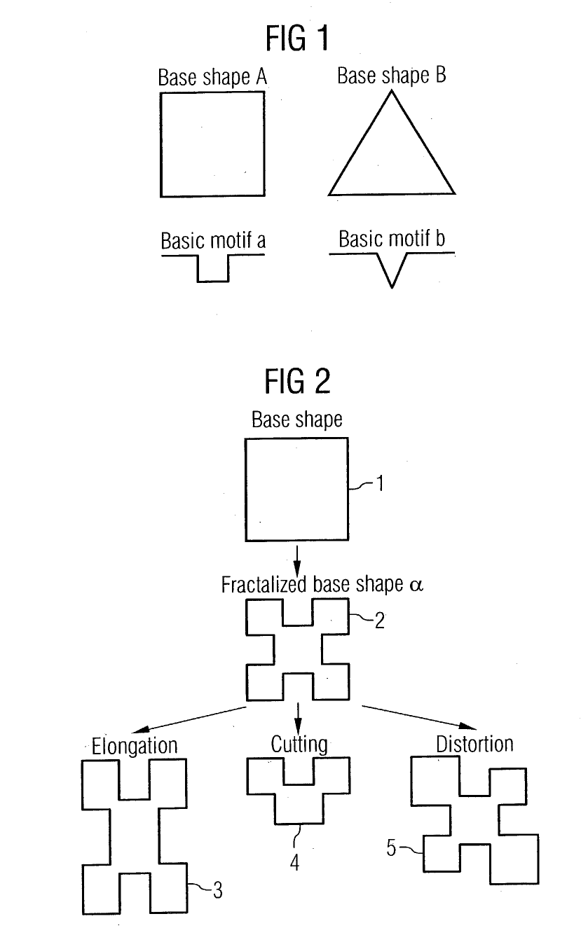

There is a requirement for ever smaller antennas, in particular in the area of mobile wireless communications and so-called “smart devices” using wireless connectivity. In order to maintain the radiating characteristics of an antenna, while reducing the size, it is know to use a plurality of fractal functions. A base shape, for example a square A, or a triangle B as shown in FIG. 1, has applied to it a basic motif, motif a and motif b respectively. The fractal function defines the basic motif in both shape and how it repeats itself, so that a self-similar pattern is generated e.g. for shape A, the pattern α, as shown in FIG. 2. Following a fractalising iterative procedure every replication lengthens the structure, and the recursive procedure is applied to a basic motif, such as Box, Cantor, Caley, Cesaro, Dragon, Hilbert, Julia, von-Koch, Mandelbrot, Minkowski, Peano-Gosper and Sierpinski. The self-similarity of these fractals allows a multi-band antenna to be produced which is significantly smaller than using a conventional antenna design. The shape of the base motif is a dominating factor when the antenna radiation pattern is considered. An antenna based purely on a recursive procedure applying fractal functions generates linear dependent replications. This limits the degree of freedom for modifying the antenna shape, for example by reducing the size of the antenna, whilst still obtaining a radiation pattern which is substantially similar for a given frequency, allowing for the fact that any modification in shape tends to give rise to a change in characteristic.

U.S. Pat. No. 6,104,349 proposes an antenna system having a fractal antenna formed by at least two replications of a fractal motif and provided with a conductive element, spaced from the fractal antenna, so that at least one characteristic of the antenna can be tuned.

This is an antenna system with linear dependent replications, although tuneable. However, it is desirable in certain circumstances to design an antenna having specific electrical and radiation properties in conjunction with a particular shape which cannot be obtained using only linear dependent replications.

In accordance with a first aspect of the present invention, a method of designing an antenna comprises at least two iterations; wherein a first iteration comprises applying a first order fractal replication to a base shape; and wherein a subsequent iteration comprises applying a non-linear replication to the result of the first or each previous iteration; such that a predetermined antenna radiation pattern is produced.

In accordance with a second aspect of the present invention an antenna comprises at least two elements; wherein the first element comprises a base shape to which a first order fractal replication has been applied; and wherein a subsequent element comprises a non-linear replication of the first or each previous element, such that a predetermined antenna radiation pattern is produced.

The present invention refines existing antennas based on fractal replication, in that it takes a first, linear, fractal replication of a base shape and applies to the result of one or more replications of that type, a non-linear replication in order to create a desired radiation pattern. This gives greater flexibility in the radiation pattern which can be achieved. The number of linear replications does not need to be the same as the number of non-linear replications, but there must be at least one of each.

A fractal motif such as Box, Cantor, Caley, Cesaro, Dragon, Hilbert, Julia, Mandelbrot, Peano-Gosper and Sierpinski may be used to provide the first order fractal replication, but preferably, the first order fractal replication comprises a von-Koch or Minkowski motif.

Preferably, the base shape is a quad loop or a triangle.

Preferably, the non-linear replication comprises at least one of 2 dimensional or 3 dimensional distortion; elongation; cutting and re-grouping.

The application of these non-linear replications creates a higher degree of freedom and increases the complexity of the design flow, making a more refined modification of the antenna radiation pattern possible.

An example of an antenna and a method of designing the antenna according to the present invention will now be described with reference to the accompanying drawings in which:—

FIG. 1 shows examples of base shapes and basic motifs for a fractal replication;

FIG. 2 illustrates the stages involved in designing an antenna according to the present invention using one of the shapes and motifs of FIG. 1;

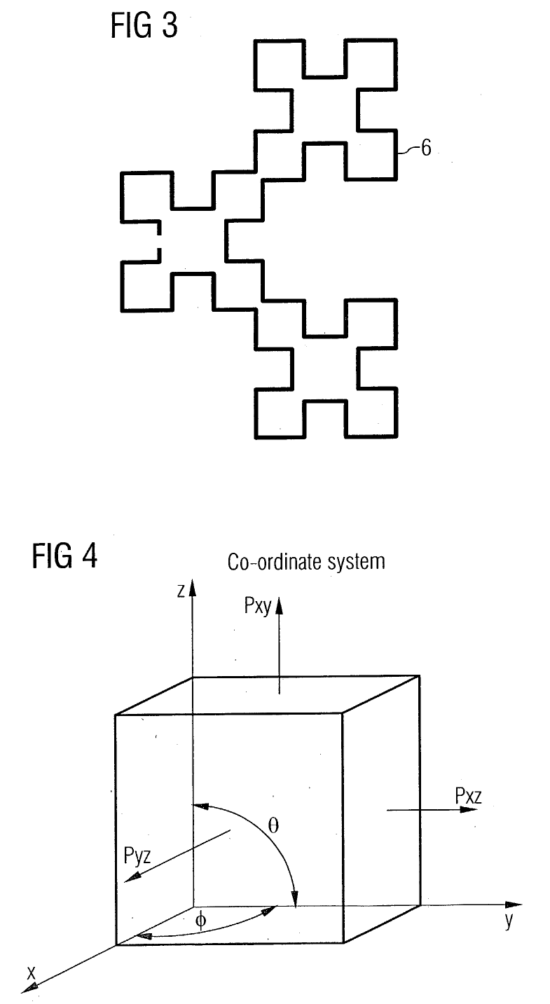

FIG. 3 is one example of an antenna designed in accordance with the present invention using a first base shape and basic motif;

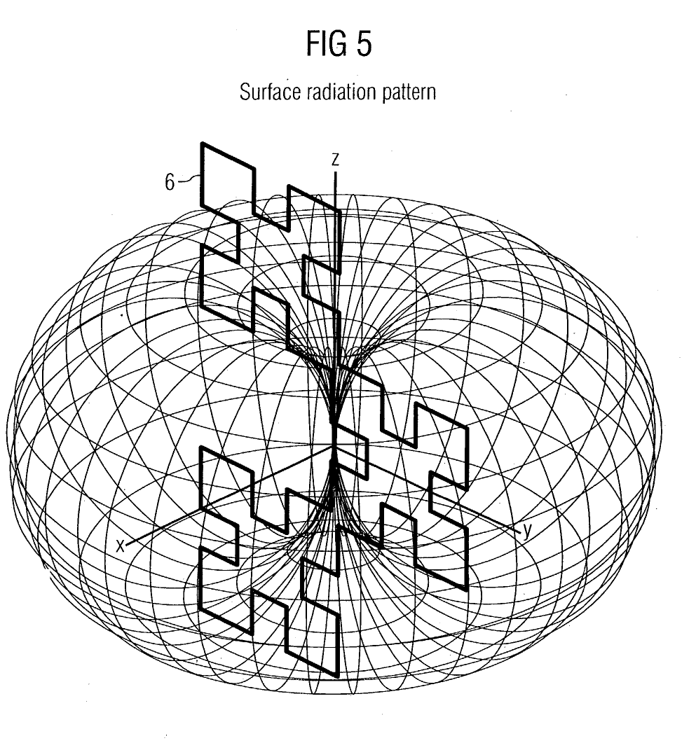

FIG. 4 illustrates a co-ordinate system by which a surface radiation pattern of the example of FIG. 3 is described;

FIG. 5 shows the surface radiation pattern of FIG. 3; and,

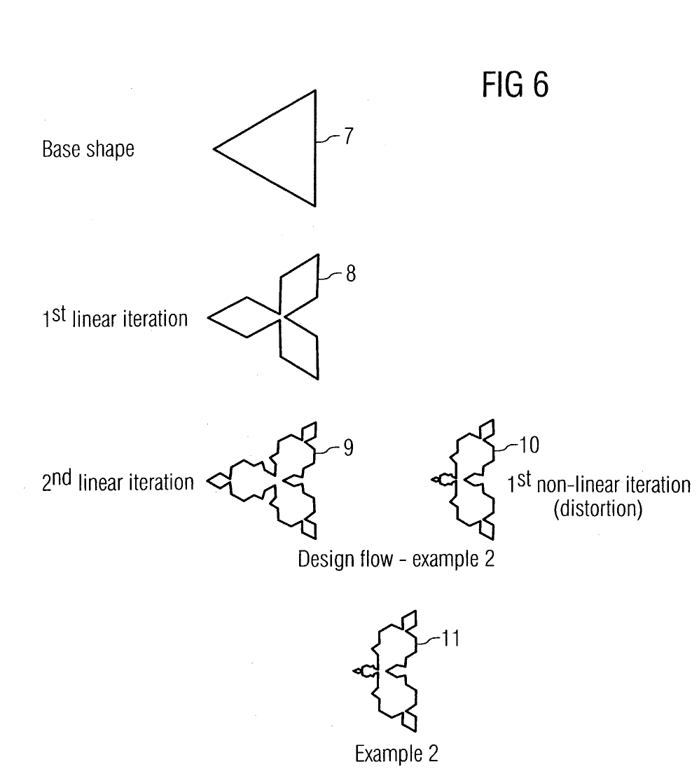

FIG. 6 is another example of an antenna designed in accordance with the present invention using a second base shape and basic motif.

FIG. 2 shows how non-linear replication techniques are used in order to manipulate the geometry of the fractalised base shape. The process of design flow when combining fractal (linear) and non-linear replication techniques as part of a recursive design procedure which can be used for any fractalised antenna design starts with base shape 1. In this example a quad loop, base shape A, has been chosen, although other base shapes can be used. The first iteration is a fractalising process in which a fractal motif, motif a, here a von-Koch curve, is applied to the base shape 1 to generate a fractalised base shape 2. Examples of non-linear manipulation which may be applied to this shape 2 are elongation 3, cutting 4 or distortion 5. More than one of these non-linear manipulations can be applied in turn. The invention is not limited to a shape generate by a single linear and a single non-linear replication, but provided that at least one linear and one non-linear replication is carried out over the complete design pattern generation process, either or both of these two steps may be repeated several times in any combination.

FIG. 3 shows a design example of an antenna 6 demonstrating the combination of linear (fractal generator based) and non-linear replication techniques. The antenna structure gives a radiation pattern which is virtually equivalent to that of a vertical orientated half-wavelength dipole. The base shape of a quad loop is fractalised by applying the von-Koch curve, and then a non-linear replication by cutting is applied to produce the antenna design.

The antenna generates a radiation field which is omni-directional in the xy-plane of the structure as shown in FIGS. 4 and 5.

FIG. 6 illustrates an alternative example of an antenna which starts from base shape B 7 and applies basic motif b to produce a first linear iteration 8. A second linear iteration 9 is produced using the same basic motif b, then a first non-linear iteration 10 is generated, in this example by distortion, to produce an antenna design pattern 11

1. A method of designing an antenna, the method comprising at least two iterations;
wherein a first iteration comprises applying a first order fractal replication to a base shape;
and wherein a subsequent iteration comprises applying a non-linear replication to the result of the first or each previous iteration; such that a predetermined antenna radiation pattern is produced.

2. A method according to claim 1, wherein the first order fractal replication comprises a von-Koch or Minkowski motif.

3. A method according to claim 1 or claim 2, wherein the base shape is a quad loop or a triangle.

4. A method according to any preceding claim, wherein the non-linear replication comprises at least one of 2 dimensional or 3 dimensional distortion; elongation; cutting and re-grouping.

5. An antenna, the antenna comprising at least two elements; wherein the first element comprises a base shape to which a first order fractal replication has been applied; and wherein a subsequent element comprises a non-linear replication of the first or each previous element, such that a predetermined antenna radiation pattern is produced.

6. An antenna according to claim 5, wherein the first order fractal replication comprises a von-Koch or Minkowski motif.

7. An antenna according to claim 5 or claim 6, wherein the base shape is a quad loop or a triangle.

8. An antenna according to any of claims 5 to 7, wherein the non-linear replication comprises at least one of 2 dimensional or 3 dimensional distortion; elongation; cutting and re-grouping.
